(19) United States
(12) Patent Application Publication
(10) Pub. No.: US 2008/0102350 A1
(43) Pub. Date: May 1, 2008

(54) Catalyst for cathode of fuel cell, preparing method and fixing method thereof, and fuel cell including same

(76) Inventors: Tetsuya Osaka, Tokyo (JP); Toshiyuki Momma, Tokyo (JP); Jong-Eun Park, Tokyo (JP)

Correspondence Address: ROBERT E. BUSHNELL, 1522 K STREET NW, SUITE 300, WASHINGTON, DC, 20005-1202, US

(21) Appl. No.: 11/976,587

(22) Filed: Oct. 25, 2007

(30) Foreign Application Priority Data
Oct. 26, 2006 (JP) 2006-291198

(51) Int. Cl. H01M 4/86; H01M 4/88

(52) U.S. Cl. 429/40

(57) ABSTRACT

A cathode catalyst for a fuel cell is inexpensive and has high durability against methanol. A method of manufacturing and fixing the cathode catalyst, and a fuel cell including it, are disclosed. The cathode catalyst includes a compound selected from the group consisting of PdSn, PdAu, PdCo, PdWO₃, and mixtures thereof. The present invention can provide a non-platinum-based cathode catalyst as a substitute for a platinum catalyst, the cathode catalyst having a low cost and improved catalyst activity, thereby contributing to popular use of a fuel cell. In addition, since the cathode catalyst of the present invention has high durability against methanol and can thereby be used with a fuel in a high concentration, it can increase the energy density of a direct methanol fuel cell (DMFC).

### CLAIM OF PRIORITY

This application makes reference to, incorporates the same herein, and claims all benefits accruing under 35 U.S.C.§119 from an application for CATALYST FOR CATHODE OF FUEL CELL, PREPARING METHOD AND FIXING METHOD THEREOF, AND FUEL CELL INCLUDING SAME earlier filed in the Japanese Intellectual Property Office on the 26^{th} of Oct. 2006 and there duly assigned Serial No. 2006-291198.

### BACKGROUND OF THE INVENTION

1. Technical Field

The present invention relates to a cathode catalyst for a fuel cell. More particularly, the present invention relates to a novel cathode catalyst which can replace a conventional platinum catalyst, a method of preparing and supporting the same, and a fuel cell including the same.

2. Related Art

Since a direct methanol fuel cell (DMFC) including a solid polymer electrolyte does not need additional devices such as a reformer and the like, it has received attention as a future small electric power source. Generally, a DMFC or a solid polymer electrolyte fuel cell (PEFC) includes carbon supported on platinum, which has high oxygen reduction activity, as a cathode catalyst. However, since platinum is in limited supply and is expensive, it has been difficult to put to practical use. Accordingly, research on improvement of catalyst activity and research on a catalyst to replace platinum, as well as development of a carbon catalyst supported on infinitesimal platinum, have been actively undertaken. The development of a non-platinum-based cathode catalyst to replace platinum has been a very critical factor for popularizing a fuel cell.

Recently, research on alloying binaries, such as a Pt-M-based group, for example Pt—Fe, Pt—Ni, Pt—Co, Pt—Cu, and the like, has been undertaken to decrease the use of platinum. However, there have been a few reports on a platinum-substituting catalyst. These reports have more or less related to a decreased use of platinum and high performance, while still requiring further performance improvement when a catalyst is included in a cell or a stack.

Recently, a Pd-Me (Me=Co, Ni, Cr) alloy catalyst prepared in a sputtering or sol-gel method has been reported to have better oxygen reduction activity in an acidic solution compared with that of platinum. However, the alloy should be prepared as particles, supported on carbon as a conductive material, and fabricated into a membrane-electrode assembly (MEA), and then evaluated. Accordingly, practical use thereof is still premature until it can be easily synthesized and have a controllable particle size. In addition, a general synthesis method of nanoparticles, i.e., an impregnation method, includes liquid reduction in a solution such as N₂H₄, NaBH₄, NaS₂O₅, and the like, and/or vapor reduction using H₂. However, this method has a problem of easy coherence of a metal when more metal is supported.

On the other hand, research on a platinum-substituting catalyst, including a metal oxide, a chalcogen, a porphyrin and the like, has proceeded. However, they all have less oxygen reduction activity than platinum. On the other hand, as research on a non-platinum-based catalyst, an oxygen reduction reaction of an organic metal complex in an alkali solution has been researched. However, the organic metal complex has been found to have a problem of stability.

In addition, NAFION®, which is widely used as an electrolyte membrane of a DMFC, has a problem in that methanol as a fuel for the DMFC permeates through the solid polymer electrolyte membrane and reaches the cathode, and is then non-electrochemically oxidized at the cathode, resulting in methanol waste as well as poisoning of an oxygen reduction catalyst which deteriorates catalyst activity. Accordingly, development of a cathode catalyst with high durability against methanol is required.

On the other hand, there have been other reports related to research on a cathode catalyst for a fuel cell, in J. L. Fernandez et al., JACS, 127, 2005, 13100-13101, Jong-Eun Park et al, Ultrasonics Sonochem., 13, 2006, 237, and Jong-Eun Park et al., Chem. Commun., 25, 2006, 2708.

### SUMMARY OF THE INVENTION

An exemplary embodiment of the present invention provides a cathode catalyst for a fuel cell, which is inexpensive and has high durability against methanol, a method of manufacturing and fixing it, and a fuel cell including it.

According to one embodiment of the present invention, a cathode catalyst for oxidant reduction of a fuel cell includes a compound selected from the group consisting of PdSn, PdAu, PdCo, PdWO₃, and mixtures thereof.

The cathode catalyst may be used for oxidant reduction in an alkaline aqueous solution.

The fuel cell may be used for a direct methanol fuel cell.

The cathode catalyst may include 40 to 95 at % of Pd of the compound.

The PdSn may have an atomic ratio of 70:30 to 50:50 between Pd and Sn. The PdAu may have an atomic ratio of 70:30 to 50:50 between Pd and Au. The PdCo may have an atomic ratio of 95:5 to 60:40 between Pd and Co. The PdWO₃ may have an atomic ratio of 90:10 to 40:60 between Pd and W.

The cathode catalyst may have an average particle diameter of 30 nm or less.

According to the embodiment of the present invention, a cathode catalyst may be selected from the group consisting of PdSn, PdAu, PdCo, PdWO₃, and mixtures thereof, and may have a superior oxidant reduction characteristic relative to a conventional platinum catalyst in an alkaline aqueous solution, and particularly in an alkaline aqueous solution with a high methanol concentration, considering the influence of methanol crossover through a solid polymer electrolyte membrane. In addition, it can selectively reduce an oxidant, even if methanol crossover from an anode to a cathode occurs, and therefore it can work with a fuel with a high concentration. It can also have excellent oxidant reduction performance, even when an alkaline aqueous solution including methanol is supplied as an oxidant and selectively reduced. Furthermore, since it may have less deteriorated oxidant reduction performance under methanol than a conventional catalyst, methanol can be supplied in a high concentration at an anode of a DMFC, accomplishing high energy density of a fuel cell.

According to another embodiment of the present invention, a method of manufacturing a cathode catalyst for a fuel cell comprises: radiating ultrasonic waves into an aqueous solution, including a metal source selected from the group consisting of metal ions, metal-containing ions, and mixtures thereof, an organic acid, and a water-soluble organic compound; and producing catalyst particles, including a metal, by reducing the metal ions or the metal-containing ions with radicals produced by the ultrasonic waves.

The metal source may be provided from metal ions selected from the group consisting of Pd, Sn, Au, Co, and W, or a water-soluble salt which is capable of supplying ions including the metals.

The aqueous solution may appropriately include a metal source in a concentration of 0.05 to 2 mmol/L based on an amount of the metal.

The organic acid may be carboxylic acid.

The organic acid may be included in a concentration of 1 to 10 mmol/L in an aqueous solution.

The water-soluble organic compound may be an alcohol.

The water-soluble organic compound may be included in a concentration of 1 to 10 mmol/L in an aqueous solution.

The ultrasonic waves may be radiated with a frequency of 15 kHz to 1.7 MHz.

In addition, the ultrasonic wave radiation may be performed at an energy flux per unit area of 10 to 90 W/cm².

It may also be performed at a temperature of 10 to 40° C.

According to the manufacturing method, a cathode catalyst cannot be cohered but is easily prepared into ultrafine particles with a nanometer size and high dispersion. The cathode catalyst can accomplish high reduction efficiency.

According to still another embodiment of the present invention, a method of fixing a cathode catalyst for a fuel cell comprises: radiating ultrasonic waves into an aqueous solution, including a metal source selected from the group consisting of metal ions, metal-containing ions, and mixtures thereof, an organic acid, and a water-soluble organic compound; producing catalyst particles, including a metal, by reducing the metal ions or the metal-containing ions with radicals produced by the ultrasonic waves; and fixing the catalyst particles on the surface of an electrode by impregnating the electrode with a mono-molecular film of an organic silane compound on the surface thereof with a solution wherein the catalyst particles are produced. According to the fixing method, an electrode can be prepared to have a cathode catalyst fixed on the surface thereof. The surface has a high degree of flatness, with surface roughness (Ra) of less than 10 nm. Accordingly, the electrode can accomplish high reduction activity due to the cathode catalyst on the surface thereof.

Since the electrode fixed with a cathode catalyst with high flatness has a structure of nanoparticles piled up one by one, unlike a membrane-type electrode, it has a relatively larger surface area, thereby increasing catalyst activity.

In general, nanoparticles are prepared in an impregnation method or a thermal reduction method. However, the impregnation method requires inclusion of a reducing agent for preparing the nanoparticles, and therefore requires an additional process to remove the reducing agent or its byproduct. On the other hand, the thermal reduction method requires a high temperature device so that nanoparticles can not only be easily synthesized but are also cohered. Therefore, the present invention provides an ultrasonic wave method in which ultrasonic waves are radiated into an aqueous solution to cause cavitation, and hydrogen radicals (H.) produced as a result can be used as a reducing agent. This method needs no reducing agent, and accordingly eliminates the need to remove the reducing agent or its byproduct, making it possible to easily prepare nanoparticles by only radiating ultrasonic waves.

According to still another embodiment of the present invention, a fuel cell including the cathode catalyst is provided.

Reduction of an oxidant in an alkaline aqueous solution may occur in the fuel cell.

The fuel cell may be a direct methanol fuel cell.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a transmission electron microscope (TEM) photograph of the PdSn catalyst particles according to Example 1.

FIG. 2 is a TEM photograph of the PdAu catalyst particles according to Example 2.

FIG. 3 is a TEM photograph of the PdCo catalyst particles according to Example 3.

FIG. 4 is a TEM photograph of the PdWO₃ catalyst particles according to Example 4.

FIG. 5 is a TEM photograph of the Pd catalyst particles according to Comparative Example 1.

FIG. 6 is a TEM photograph of the Pd catalyst particles according to Comparative Example 2.

FIG. 7 is a cyclic voltammogram showing oxidant reduction characteristics of catalysts according to Examples 5 to 8 and Comparative Examples 3 and 4 in a KOH aqueous solution.

FIG. 8 is a cyclic voltammogram showing oxidant reduction characteristics of catalysts according to Examples 5 to 8 and Comparative Examples 3 and 4 in a KOH aqueous solution including methanol.

### DETAILED DESCRIPTION OF THE INVENTION

According to one embodiment of the present invention, a cathode catalyst for a fuel cell may be used for reduction of an oxidant, and may be selected from the group consisting of PdSn, PdAu, PdCo, PdWO₃, and mixtures thereof.

The cathode catalyst of the present invention selected from the group consisting of PdSn, PdAu, PdCo, PdWO₃, and mixtures thereof, has a superior reduction characteristic relative to a conventional platinum catalyst in an alkaline aqueous solution or in a methanol aqueous solution including methanol in a high concentration, for example 0.1 to 2 mol/L, particularly in a methanol-alkaline aqueous solution, considering the influence of the methanol due to its crossover through a solid polymer electrolyte membrane. Accordingly, it can appropriately reduce an oxidant such as oxygen (O₂), ozone (O₃), and hydrogen peroxide (H₂O₂) in a fuel cell.

In addition, since an oxidant can be selectively reduced, even when methanol crossover occurs from an anode to a cathode, a fuel with a high concentration can be used. Furthermore, when an alkaline aqueous solution, including methanol, is supplied as an oxidant and then selectively reduced, a fuel cell can have high oxidant reduction performance. Since the cathode catalyst has less deteriorated reduction performance than a conventional one using methanol as a fuel, methanol in a high concentration can be supplied to a cathode, particularly in a DMFC, accomplishing high energy density of a fuel cell.

The cathode catalyst of the present invention is not limited with respect to atomic ratio of Pd and the other metal (M) (M=Sn, Au, Co, or W), except that the Pd but may be present in an atomic ratio of 95:5 to 40:60 with regard to the other metal (M). In particular, PdSn may have a ratio of Pd:Sn=70:30 to 50:50, PdAu may have a ratio of Pd:Au=70:30 to 50:50, PdCo may have a ratio of Pd:Co=95:5 to 60:40, and PdWO₃ may have a ratio of Pd:W=90:10 to 40:60.

According to another embodiment of the present invention, a method of manufacturing the cathode catalyst is provided.

The cathode catalyst can be prepared by radiating ultrasonic waves into an aqueous solution, including a metal source selected from the group consisting of metal ions, metal-containing ions, and mixtures thereof, an organic acid, and a water-soluble organic compound. When ultrasonic waves are radiated into a liquid, cavitation occurs. The produced cavities grow and implosively collapse, and then locally generate hot spots by adiabatic compression or a shock wave inside the collapsed cavities.

The hot spots reach a temperature of 5000K at a maximum, and a pressure of 2000 atm. It is under this atmosphere that hydrogen radicals (H.) and hydroxy radicals (HO.) are produced from H₂O, and the hydrogen radicals reduce metal ions or metal-containing ions, and thereby produce catalyst particles (alloy particles).

The catalyst particles are produced according to the following reaction:

H₂O→H.+HO. (1)

RH(organic material)+HO.→R.+H₂O (2)

RH(organic material)→organic thermal decomposition radical (3)

nH.+M⁺→M+nH⁺ (4)

nR.+M⁺→M+R′+nH⁺ (5)

n(M⁰)→(M⁰)ₙ (6)

The aqueous solution for radiation of ultrasonic waves includes a metal source selected from the group consisting of metal ions, metal-containing ions, and mixtures thereof. It may be provided from a water-soluble salt including: metal ions (i.e., Pd, Sn, Au, Co, or W) respectively corresponding to PdSn, PdAu, PdCo, and PdWO₃; or ions containing the metals, for example ions of a metal acid, ions of a chloro metal-acid, and the like. For example, Pd may be provided from a water-soluble salt such as (NH₄)₂PdCl₄, PdCl₂, and the like; Sn may be provided from a water-soluble salt such as SnCl₂.2H₂O, SnCl₂, and the like; Au may be provided from a water-soluble salt such as NaAuCl₄.2H₂O, HAuCl₄, and the like; Co may be provided from a water-soluble salt such as CoSO₄.7H₂O, CoCl₂, CoCl₂(H₂O)₆, and the like; and W may be provided from a water-soluble salt such as Na₂WO₄.2H₂O and the like. The metal source, including metal ions and/or metal-containing ions, may be included in an amount of 0.05 to 2 mmol/L based on the amount of the metal such as Pd, Sn, Au, Co, or W.

In addition, the aqueous solution may include an organic acid. The organic acid is added to improve dispersion of catalyst particles produced from the aforementioned reaction. The organic acid may include carboxylic acid, and particularly hydroxycarboxylic acid. More specifically, it may include citric acid, glyceric acid, glycolic acid, isocitric acid, and the like. The hydroxycarboxylic acid coordinates the prepared catalyst particles, and can thereby suppress coherence of the catalyst particles. The organic acid may be included in a concentration of 1 to 10 mmol/L based on the entire amount of aqueous solution.

The aqueous solution may include a water-soluble organic compound as an organic compound other than the organic acid. The water-soluble organic compound may work as an organic material in the aforementioned reaction. The water-soluble organic compound may include alcohols, such as methanol, ethanol, propanol, propyleneglycol, and the like. In addition, the water-soluble organic compound may be included in a concentration of 1 to 10 mmol/L of the aqueous solution.

When the aqueous solution is radiated by ultrasonic waves, as described above, hydrogen radicals (H.) are generated therefrom. The hydrogen radicals and radicals (R.), produced from an organic material reacting with hydroxy radicals (OH.), reduce the metal ions or metal-containing ions, producing catalyst particles (alloy particles) including the metal. The produced catalyst particles can be separated and gained from the solution in a common method. However, when it is fixed on the surface of an electrode, a dispersion solution including the catalyst particles can be used for fixation.

The ultrasonic wave radiation may include using a device for radiating ultrasonic waves. The radiation can be performed under appropriate conditions, for example, at a frequency of 15 kHz to 1.7 MHz and energy flux per unit area of 10 to 90 W/cm². In addition, the radiation temperature (aqueous solution temperature) may be around room temperature, for example, 10 to 40° C. The radiation time may be in a range of 0.5 to 4 hours.

When the cathode catalyst of the present invention is prepared as particles, the average particle diameter may be less than 30 nm, and particularly may be in a range of 4 to 10 nm. This average particle diameter can be measured with a transmission electronic microscope, for example.

According to another embodiment of the present invention, a method of fixing catalyst particles prepared in the aforementioned method on the surface of an electrode is provided.

The catalyst particles may be fixed on a monomolecular film, made of an organic silane compound, after the monomolecular film made of an organic silane compound is first disposed on the surface of an electrode. The electrode may be a conductive material which not only functions as an electrode, but which can also form an OH group, since an organic silane compound film is disposed thereon. Accordingly, it may include a conductive metal oxide such as ITO (indium tin oxide) and the like. This conductive metal oxide can form an OH group thereon by treating the surface with an impregnation method. According to the method, a conductive metal oxide as an electrode is impregnated with an alkaline aqueous solution.

An alkaline treatment process by using the alkaline aqueous solution is performed to wash an electrode and to form an OH group on the surface of the electrode. The OH group on the surface of the electrode reacts with an alkoxy group of the organic silane compounds to form a monomolecular film made of an organic silane compound on the electrode.

When the alkaline treatment process is performed, hydroxides including a metal selected from the group consisting of an alkaline metal, an alkaline earth metal, and combinations thereof may be used as an alkaline material, such as KOH, NaOH etc. The alkaline material may be included in a concentration of 0.01 to 5 mol/L based on the entire amount of alkaline aqueous solution.

Next, the electrode includes a monomolecular film with the organic silane compound thereon. The monomolecular film of the organic silane compound may include an organic silane compound having an amino group such as N-(2-aminoethyl)-3-aminopropyl trimethoxysilane, 3-aminopropyl trimethoxysilane, 3-aminopropyltriethoxysilane, 2-(trimethoxysilyl)ethyl-2-pyridine, (aminoethyl)-penethyltrimethoxysilane, and the like, and simultaneously an alkoxy group. In particular, it can appropriately contribute to easily fixing and adhering to catalyst particles. For example, an OH group formed on the surface of the electrode performs a hydrolysis reaction with an alkoxy group of the organic silane compound, through which the organic silane compound is bound to the electrode. The organic silane compound forms a monomolecular film where an amino group is arranged in a direction opposite to that of the electrode.

The monomolecular film of the organic silane compound can be formed by either a vaporizing method or a solution method. The solution method may be the simpler and more productive method. The solution method can include using a solution prepared by dissolving an organic silane compound in a solvent. The solution is used to impregnate an electrode with an OH group so that the electrode can contact the organic silane compound to form a monomolecular film of an organic silane compound. The solvent may include an alcohol, such as methanol and ethanol, or a hydrocarbon-based solvent, such as toluene and the like.

The organic silane compound solution may have a concentration of 0.2 to 3 mass % and particularly about 1 mass %, although it can have various concentrations depending on the contact (impregnation) time of an electrode. In addition, the organic silane compound solution can be used at a temperature of 20 to 90° C. However, it can be used at a temperature of 40 to 70° C. or a temperature of 50 to 60° C. according to another embodiment of the present invention. On the other hand, the impregnation time can be appropriately regulated depending on the concentration of an organic silane compound and the temperature of the solution including it, but it may be in a range of 1 minute to 12 hours, and particularly from 5 minutes to 12 hours.

After treating the electrode with an organic silane compound as aforementioned, excessive organic silane compound is removed to form a monomolecular film of the organic silane compound on the electrode. The excessive organic silane compound can be removed in various ways. The removal method may include contacting an electrode with alcohol, such as ethanol and the like, or a mixed solution of alcohol and water, impregnating an electrode in the solution, or the like. Herein, it can additionally include washing with ultrasonic waves.

Next, the electrode including a monomolecular film of the organic silane compound is impregnated with a dispersion solution including catalyst particles produced by radiating ultrasonic waves in the aforementioned method so as to fix the catalyst particles on the electrode. The catalyst particles in the disperse solution are fixed on the electrode through a monomolecular film of an organic silane compound, since the catalyst particles are coordinated outward by an organic acid with a carboxyl group, so that the carboxyl group can react with an amino group of the organic silane compound of the monomolecular film.

The fixation of the catalyst particles can be performed at about room temperature, for example, at a temperature of 10 to 40° C., for 0.5 to 24 hours. Furthermore, the catalyst particles may be fixed to be about 70 to 200 nm thick.

According to the fixation method, an electrode fixed with catalyst particles has a surface roughness of Ra=10 nm or less. However, it can have a surface roughness of less than Ra=8 nm or Ra=5 to 7 nm according to another embodiment. Accordingly, since the electrode of the present invention includes catalyst particles fixed thereon, and also has good surface flatness and a three-dimensional structure of piled nanoparticles, it can improve catalyst activity and efficiency.

The cathode catalyst of the present invention may be appropriately used for a fuel cell, and particularly for a direct methanol fuel cell, since it can reduce an oxidant in an alkaline aqueous solution.

According to another embodiment of the present invention, a fuel cell including the cathode catalyst is provided.

Herein, when a fuel cell is fabricated according to the aforementioned method, it can include other conventional components so long as it includes a palladium-base catalyst as a cathode catalyst,

The following examples illustrate the present invention in more detail. However, the present invention is not limited to the following examples.

### EXAMPLE 1

10 ml of ethanol was added to 100 mL of an aqueous solution including 0.2 mmol/L (NH₄)₂PdCl₄, 0.2 mmol/L SnCl₂.2H₂O, and 4 mmol/L citric acid. 150 mL of the resulting aqueous solution was put in a glass beaker and then radiated with ultrasonic waves at 20 kHz and 55 W (42 W/cm²) at a temperature of 25±2° C. for 2 hours by using a Sonifier 450D (Branson Co.), producing PdSn alloy nanoparticles.

The produced PdSn alloy nanoparticles were measured with respect to their atomic ratio of Pd and Sn by using X-ray photoelectron spectroscopy (XPS). The result was Pd₇₀Sn₃₀.

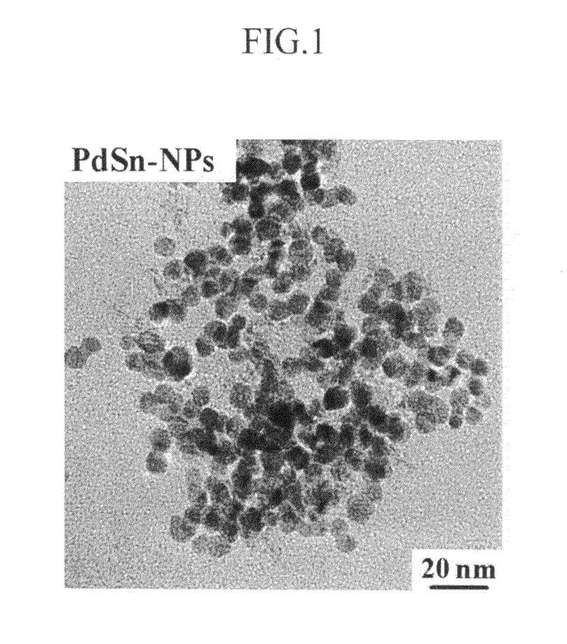

In addition, they were examined with a transmission electron microscope (TEM). The result is shown in FIG. 1.

As shown in FIG. 1, the particles turned out to have a particle diameter ranging from 8 to 10 nm based on the TEM.

### EXAMPLE 2

PdAu alloy nanoparticles were prepared according to the same method as in Example 1, except that NaAuCl₄.2H₂O instead of SnCl₂.2H₂O was included.

Then, they were measured with respect to their atomic ratio of Pd and Sn by using X-ray photoelectron spectroscopy (XPS) according to the same method as in Example 1. The result was Pd₈₅Au₁₅.

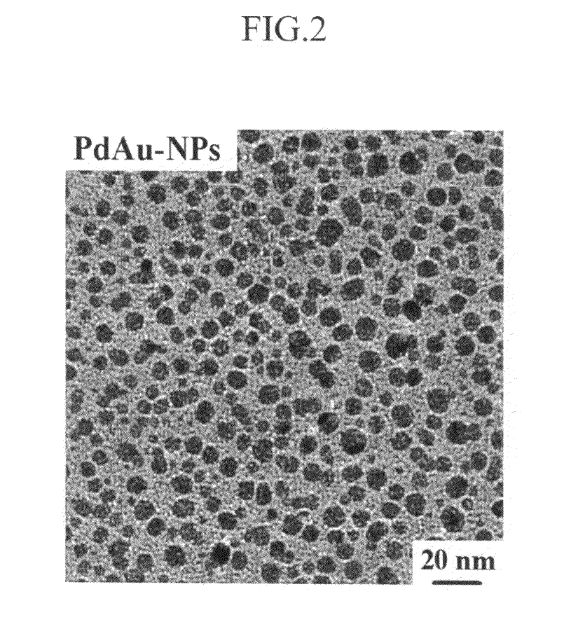

In addition, they were examined by using a transmission electron microscope (TEM). The result is shown in FIG. 2.

As shown in FIG. 2, the PdAu alloy nanoparticles had a particle diameter of 6 to 7 nm based on the TEM.

### EXAMPLE 3

PdCo alloy nanoparticles were produced according to the same method as in Example 1, except that CoSO₄.7H₂O instead of SnCl₂.2H₂O was included.

Then, the PdCo alloy nanoparticles were measured with respect to atomic ratio of Pd 4 and Co by using X-ray photoelectron spectroscopy (XPS) according to the same method as in Example 1. The result was Pd₉₅CO₅.

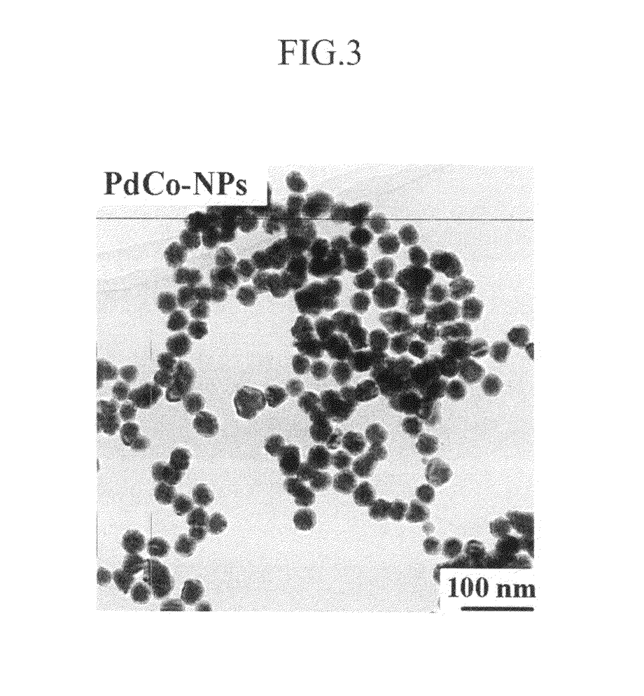

In addition, they were examined by using a TEM. The result is shown in FIG. 3.

As shown in FIG. 3, they had a particle diameter of 30 nm based on the TEM.

### EXAMPLE 4

PdCo alloy nanoparticles were produced according to the same method as in Example 1, except that Na₂WO₄.2H₂O instead of SnCl₂.2H₂O was included.

The PdCo alloy nanoparticles were measured with respect to atomic ratio of Pd and WO₃ by using an XPS according to the same method as in Example 1. The result was Pd₆₀(WO₃)₄₀.

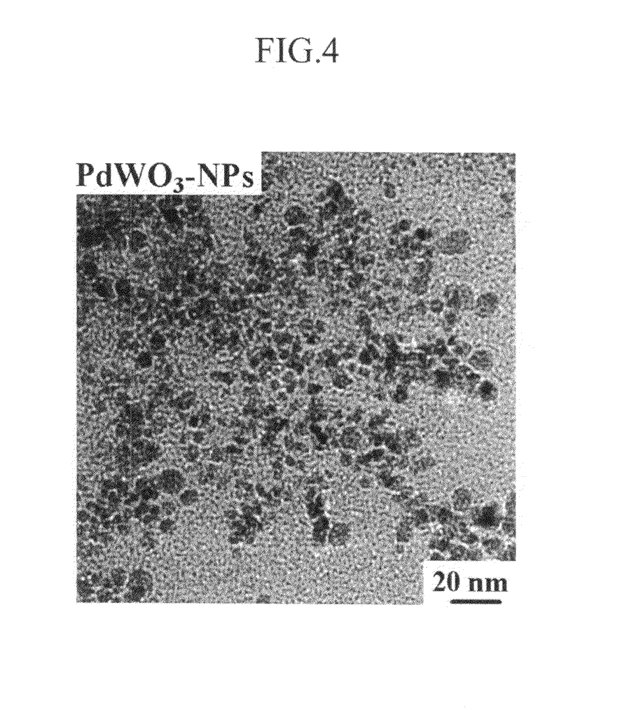

In addition, they were examined by using a TEM. The result is shown in FIG. 4.

As shown in FIG. 4, they had a particle diameter ranging from 7 to 8 nm based on the TEM.

### COMPARATIVE EXAMPLE 1

PdCo alloy nanoparticles were produced according to the same method as in Example 1, except that 0.2 mmol/L (NH₄)₂PdCl₄ instead of SnCl₂.2H₂O was included.

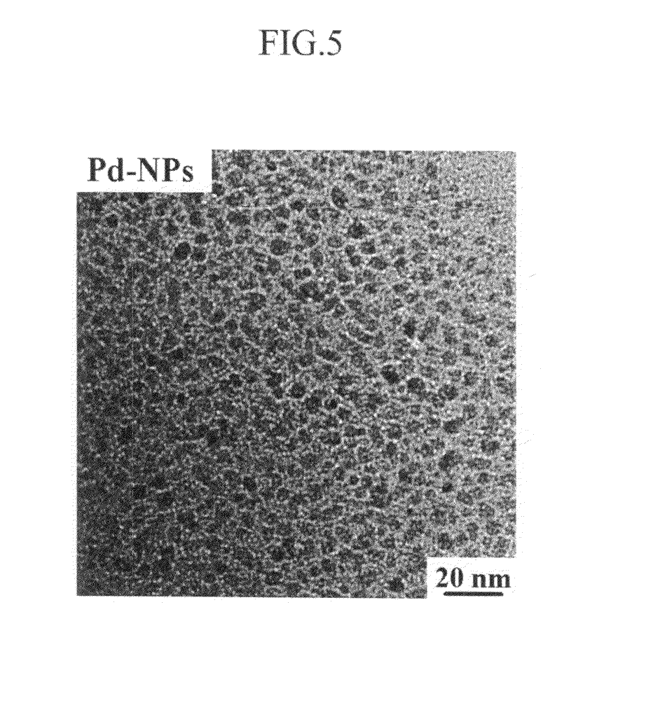

They were examined by using a TEM according to the same method as in Example 1. The result is shown in FIG. 5.

As shown in FIG. 5, they had a particle diameter of 4 to 5 nm based on the TEM.

### COMPARATIVE EXAMPLE 2

Pt nanoparticles were produced according to the same method as in Example 1, except that 0.2 mmol/L H₂PtCl₆.6H₂O instead of (NH₄)₂PdCl₄ and SnCl₂.2H₂O was included.

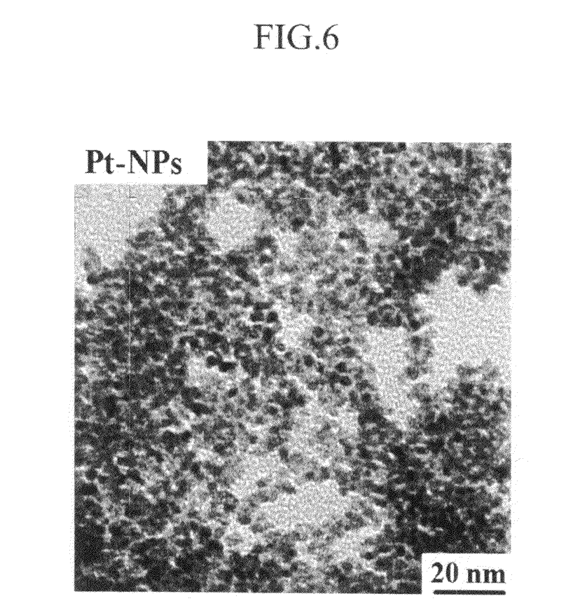

They were examined according to the same method as in Example 1 by using a TEM. The result is shown in FIG. 6.

As shown in FIG. 6, the Pt nanoparticles had a particle diameter ranging from 2 to 3 nm based on the TEM.

### EXAMPLE 5

An ITO electrode was impregnated with a 1 mol/L KOH aqueous solution for washing and for simultaneously forming an OH group thereon. Next, the ITO electrode, including an OH group on the surface, was impregnated with a 2.5 mass % γ-aminopropyltriethoxysilane (APS)-toluene solution at 25° C. for 6 hours so as to dispose an APS mono-molecular film thereon. Then, the electrode with a mono-molecular film was immersed in a solution, wherein PdSn alloy nanoparticles (catalyst particles) were produced, at 25° C. for 12 hours so as to fix the APS mono-molecular film on the surface.

The electrode fixed with catalyst particles was examined with respect to surface roughness by using an atomic force microscope (AFM). The surface roughness was determined by evaluating the AFM image.

The result was Ra=7 nm.

### EXAMPLE 6

An ITO electrode was prepared so as to be fixed with catalyst particles through an APS mono-molecular film on the surface according to the same method as in Example 5 except that a solution produced with PdAu alloy nanoparticles of Example 2 was used.

### EXAMPLE 7

An ITO electrode was prepared so as to be fixed with catalyst particles through an APS mono-molecular film on the surface according to the same method as in Example 5 except that a solution produced with PdCo alloy nanoparticles of Example 3 was used.

### EXAMPLE 8

An ITO electrode was prepared so as to be fixed with catalyst particles through an APS mono-molecular film on the surface according to the same method as in Example 5 except that a solution produced with PdWO₃ alloy nanoparticles of Example 4 was used.

### COMPARATIVE EXAMPLE 3

An ITO electrode was prepared so as to be fixed with catalyst particles through an APS mono-molecular film on the surface according to the same method as in Example 5 except that a solution produced with Pd nanoparticles of Comparative Example 1 was used.

The electrode fixed with catalyst particles was measured with respect to surface roughness by using an atomic force microscope (AFM). The surface roughness was determined by evaluating the AFM image. The result was Ra=10 nm.

### COMPARATIVE EXAMPLE 4

An ITO electrode was prepared so as to be fixed with catalyst particles through an APS mono-molecular film on the surface according to the same method as in Example 5 except that a solution produced with Pt nanoparticles of Comparative Example 2 was used.

The electrode fixed with catalyst particles was measured with respect to surface roughness by using an atomic force microscope (AFM). The surface roughness was determined by evaluating the AFM image. The result was Ra=13 nm.

The electrodes according to Examples 5 to 8 and Comparative Examples 3 and 4 were evaluated with respect to reduction of an oxidant in a cyclic voltammetry (CV) method.

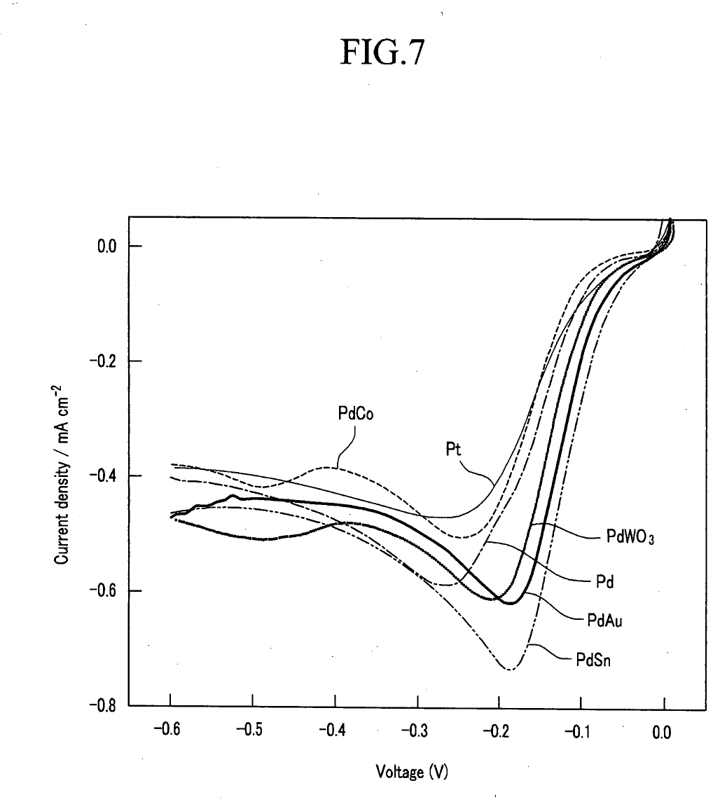

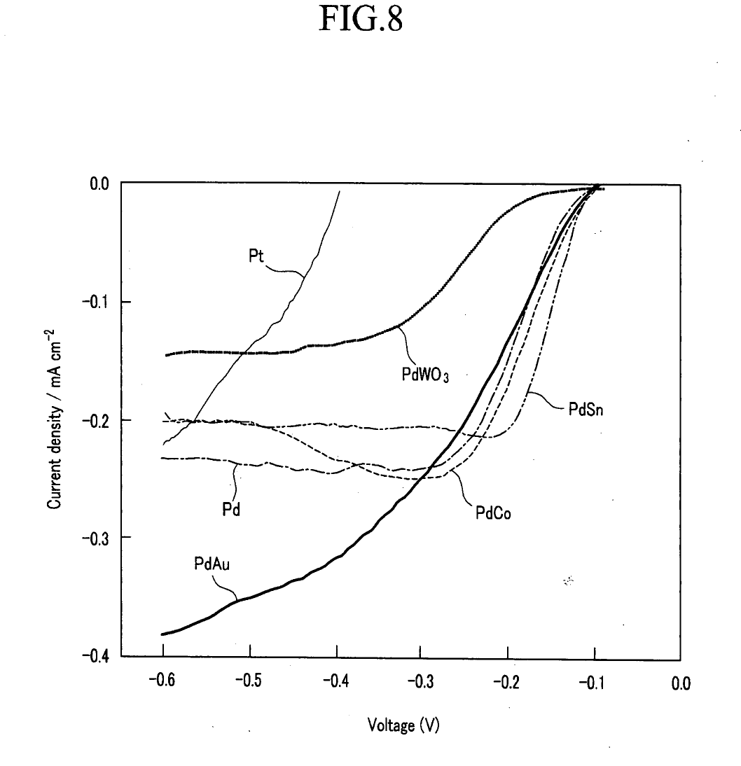

The catalysts were cathode-scanned at a speed of 100 mV/s and thereby evaluated with respect to the following two items: (a) saturated oxygen in an aqueous solution including 0.5 mol/L KOH; and (b) saturated oxygen in an aqueous solution including 0.5 mol/L KOH and 2 mol/L methanol. The results of (a) and (b) are shown in FIGS. 7 and 8, respectively.

In FIGS. 7 and 8, the X-axis [E/V vs. Ag/AgCl] is a voltage of the working electrode (palladium-based Pt nano particle-containing electrode) to the reference electrode (Ag/AgCl), and the Y-axis is current density (mA/cm²).

As shown in FIG. 7, the cathode catalysts according to Examples 5 to 8 turned out to have an oxidant reduction characteristic superior to that of the platinum catalyst of Comparative Example 4 in an alkali solution. The oxidant reduction performance in an alkali solution was on the order of PdSn>PdAu>PdWO₃>PdCo.

In addition, as shown in FIG. 8, the platinum catalyst of Comparative Example 4 had an oxygen reduction potential that shifted to negative 400 mV under 2 mol/L methanol compared with no methanol in FIG. 7. The cathode catalysts of Examples 5 to 8 had small oxygen reduction potential shifts of about 50 mV even in 2 mol/L methanol. The oxidant reduction performance in methanol was on the order of PdSn>PdCo>PdAu>PdWO₃. Based on the above results, a cathode catalyst of the present invention turned out to have no influence on methanol crossover in a solid polymer electrolyte membrane such as NAFION® and the like. Accordingly, a fuel cell of the present invention can include methanol in a high concentration, and can thereby achieve high energy density.

In addition, the cathode catalysts according to Examples 5 to 8 showed the different oxidant reduction characteristic depending on the presence of methanol due to a different oxygen reduction activity.

Therefore, the present invention can provide a non-platinum-based cathode catalyst as a substitute for a platinum catalyst, and can have low cost and improved catalyst activity, and can thereby contribute to popular use of a fuel cell. In addition, since the cathode catalyst of the present invention has high durability relative to methanol, and thereby includes a fuel in a high concentration, it can increase the energy density of a DMFC. Furthermore, it can be used as a platinum-substituting catalyst in electrochemical fields, such as for a solid polymer-type fuel cell, for various industrial electrolytes, for corrosion reduction, and the like, and particularly as a cathode catalyst for a fuel cell, thereby having a great influence on the industry.

While this invention has been described in connection with what is presently considered to be practical exemplary embodiments, it is to be understood that the invention is not limited to the disclosed embodiments, but, on the contrary, it is intended to cover various modifications and equivalent arrangements included within the spirit and scope of the appended claims.

What is claimed is:

1. A cathode catalyst for a fuel cell, comprising a compound selected from the group consisting of PdSn, PdAu, PdCo, PdWO₃, and mixtures thereof;
wherein the cathode catalyst is adapted for oxidant reduction of the fuel cell.

2. The cathode catalyst of claim 1, wherein the cathode catalyst is used for oxidant reduction in an alkaline aqueous solution.

3. The cathode catalyst of claim 1, wherein the fuel cell is used for a direct methanol fuel cell.

4. The cathode catalyst of claim 1, wherein the cathode catalyst comprises Pd in a range of 40 to 95 at % of the compound.

5. The cathode catalyst of claim 1, wherein the PdSn has an atomic ratio in a range of 70:30 to 50:50 between Pd and Sn;
wherein the PdAu has an atomic ratio in a range of 70:30 to 50:50 between Pd and Au; and
wherein the PdCo has an atomic ratio in a range of 95:5 to 60:40 between Pd and Co.

6. The cathode catalyst of claim 1, wherein the cathode catalyst has an average particle diameter not greater than 30 nm.

7. A method of manufacturing a cathode catalyst for a fuel cell, comprising the steps of:
radiating ultrasonic waves into an aqueous solution, including a metal source selected from the group consisting of metal ions, metal-containing ions, and mixtures thereof, an organic acid, and a water-soluble organic compound; and
producing catalyst particles, including a metal, by reducing one of the metal ions and the metal-containing ions with radicals produced by the ultrasonic waves.

8. The method of claim 7, wherein the metal source is provided from metal ions selected from the group consisting of Pd, Sn, Au, Co and W, or a water-soluble salt capable of supplying ions including the metals.

9. The method of claim 7, wherein the aqueous solution comprises a metal source in a concentration in a range of 0.05 to 2 mmol/L based on an amount of the metal.

10. The method of claim 7, wherein the organic acid is carboxylic acid.

11. The method of claim 7, wherein the organic acid is included in a concentration in a range of 1 to 10 mmol/L in an aqueous solution.

12. The method of claim 7, wherein the water-soluble organic compound is an alcohol.

13. The method of claim 7, wherein the water-soluble organic compound is included in a concentration in a range of 1 to 10 mmol/L in an aqueous solution.

14. The method of claim 7, wherein the ultrasonic waves are radiated with a frequency in a range of 15 kHz to 1.7 MHz.

15. The method of claim 7, wherein the ultrasonic wave radiation is performed with energy flux per unit area in a range of 10 to 90 W/cm².

16. The method of claim 7, wherein the ultrasonic wave radiation is performed at a temperature in a range of 10 to 40° C.

17. A method of fixing a cathode catalyst for a fuel cell, comprising the steps of:
radiating ultrasonic waves into an aqueous solution, including a metal source selected from the group consisting of metal ions, metal-containing ions, and mixtures thereof, an organic acid, and a water-soluble organic compound;
producing catalyst particles, including a metal, by reducing one of the metal ions and the metal-containing ions with radicals produced by the ultrasonic waves; and
fixing the catalyst particles on a surface of an electrode by impregnating the electrode with a mono-molecular film of an organic silane compound on the surface in a solution wherein the catalyst particles are produced.

18. A fuel cell, comprising a cathode catalyst;
said cathode catalyst comprising a compound selected from the group consisting of PdSn, PdAu, PdCo, PdWO₃, and mixtures thereof;
wherein the cathode catalyst is adapted for oxidant reduction of the fuel cell.

19. The fuel cell of claim 18, wherein the fuel cell is adapted for oxidant reduction in an alkaline aqueous solution.

20. The fuel cell of claim 18, wherein the fuel cell is adapted so as to form a direct methanol fuel cell.
